(19) United States
(12) Patent Application Publication
(10) Pub. No.: US 2005/0078184 A1
(43) Pub. Date: Apr. 14, 2005

(54) Monitoring system

(75) Inventors: Shinji Sakai, Kawanishi-shi (JP); Daisuke Horie, Uji-shi (JP); Youichi Kawakami, Tondabayashi-shi (JP); Yuusuke Nakano, Akashi-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA HOLDINGS, INC.

(21) Appl. No.: 10/956,792

(22) Filed: Oct. 1, 2004

(30) Foreign Application Priority Data
Oct. 10, 2003 (JP) P2003-352091

(51) Int. Cl. H04N 9/47

(52) U.S. Cl. 348/143

(57) ABSTRACT

The present invention provides a monitoring system capable of performing monitoring operation more efficiently. The monitoring system has a plurality of cameras. In the monitoring system, on the basis of an image captured by at least one of the cameras, a plurality of persons included in the captured image is detected, and detection information of the plurality of persons is obtained. On the basis of the detection information, the image capturing condition of at least one camera is changed. For example, when the number of persons detected is larger than a predetermined value, the image capturing region of at least one camera is changed.

This application is based on application No. 2003-352091 filed in Japan, the contents of which are hereby incorporated by reference.

### BACKGROUND OF THE INVENTION

1. Field of the Invention

The present invention relates to a monitoring system using images captured by a plurality of cameras.

2. Description of the Background Art

There is a technique of providing a monitoring camera in a shop such as a convenience store or a bank from the viewpoint of prevention of crime.

One of such techniques of a monitoring camera is disclosed in Japanese Patent Application Laid-Open No. 2000-245560. The publication discloses a technique of counting the number of persons in each of monitoring areas and, when the number becomes one, monitoring the one person by panning/tilting/zooming operation.

In some uses of monitoring, it is requested to monitor a plurality of persons, so that efficient monitoring operation is required.

The technique of the above publication for monitoring one person, however, has a problem in that sufficient monitoring operation cannot be performed at the time of monitoring a plurality of persons.

### SUMMARY OF THE INVENTION

An object of the present invention is to provide a monitoring system capable of performing a monitoring operation more efficiently.

In order to achieve the object, according to a first aspect of the present invention, a monitoring system comprises: a plurality of image capturing parts; an information obtaining part for obtaining detection information regarding a plurality of persons included in an image captured by at least one of the plurality of image capturing parts on the basis of the image; and a controller for changing an image capturing condition of at least one of the plurality of image capturing parts on the basis of the detection information.

According to the monitoring system, it is possible to monitor a plurality of persons more efficiently.

According to a second aspect of the present invention, a monitoring system comprises: a plurality of image capturing parts; an information obtaining part for obtaining detection information regarding travel directions of a plurality of persons on the basis of an image captured by at least one of the plurality of image capturing parts; and a controller for determining a particular image capturing part corresponding to at least one of the plurality of persons on the basis of the travel directions of the plurality of persons, and instructing the particular image capturing part to capture a front view image of the at least one of the plurality of persons.

According to the monitoring system, it is possible to trace a plurality of persons in liaison and to monitor a plurality of persons more efficiently. Since a front view image can be captured, the monitoring system is very convenient.

The present invention is also directed to a monitoring method and a computer program product.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic configuration of a monitoring system according to a first preferred embodiment;

FIG. 2 is a functional block diagram showing a schematic configuration of a camera;

FIG. 3 is a side view of the camera;

FIG. 4 is a top view showing layout of cameras;

FIG. 5 is a side view showing image capturing regions of the cameras;

FIG. 6 is a side view showing changed image capturing regions of the cameras;

FIG. 7 is a side view showing an image capturing state according to a modification of the first preferred embodiment;

FIG. 8 is a diagram showing an image capturing state (before division of a region) according to a second preferred embodiment;

FIG. 9 is a diagram showing an image capturing state (after division of a region) according to the second preferred embodiment;

FIG. 10 is a diagram showing an image capturing state (before change of an angle of view) according to a third preferred embodiment;

FIG. 11 is a diagram showing an image capturing state (after change of an angle of view) according to the third preferred embodiment;

FIG. 12 is a diagram showing an image capturing state according to a fourth preferred embodiment;

FIG. 13 is a diagram showing another image capturing state according to the fourth preferred embodiment;

FIG. 14 is a top view showing a modification of the fourth preferred embodiment;

FIG. 15 is a diagram showing an image capturing state according to a fifth preferred embodiment;

FIG. 16 is a diagram showing another image capturing state according to the fifth preferred embodiment; and

FIG. 17 is a diagram showing an image capturing state according to a sixth preferred embodiment.

### DESCRIPTION OF THE PREFERRED EMBODIMENTS

Hereinafter, preferred embodiments of the present invention will be described with reference to the drawings.

### First Preferred Embodiment

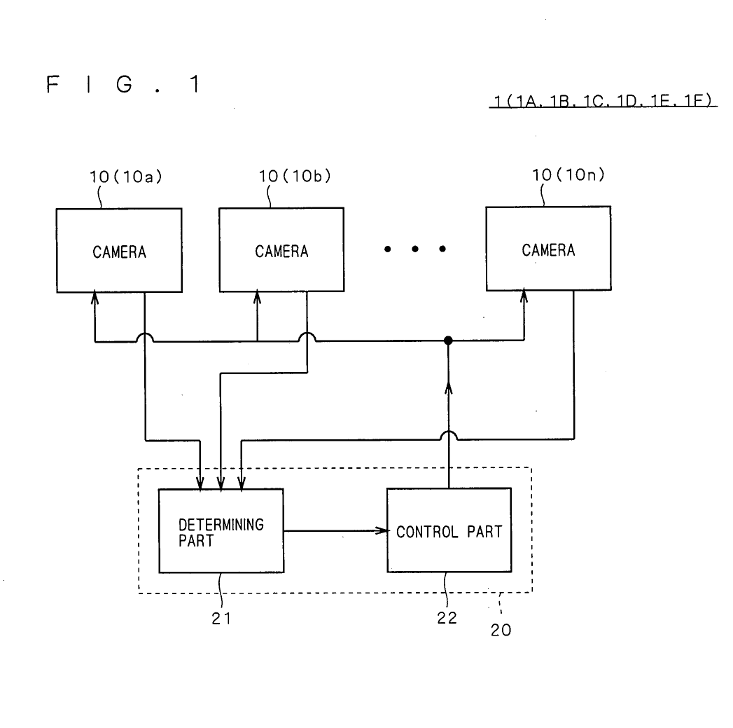

FIG. 1 is a diagram showing a schematic configuration of a monitoring system 1 (1A) according to a first preferred embodiment.

As shown in FIG. 1, the monitoring system 1A comprises a plurality of cameras 10 (10a, 10b, . . . , and 10n) and a controller 20.

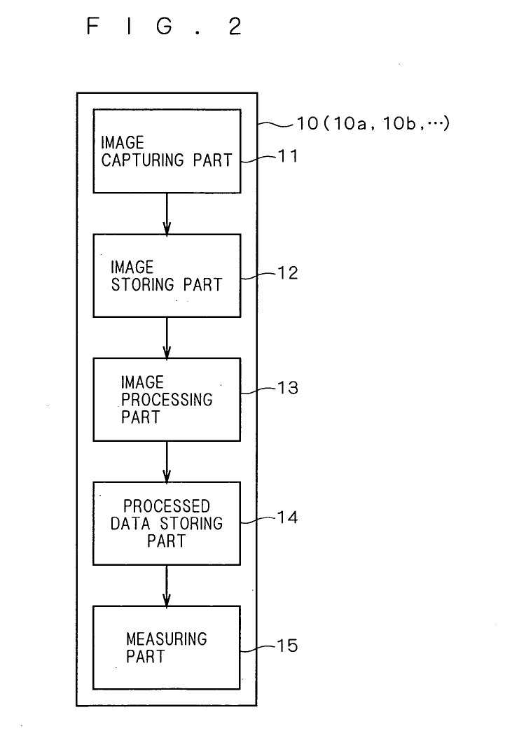

FIG. 2 is a functional block diagram showing a schematic configuration of each of the cameras 10. It is assumed herein that the cameras 10a, 10b, . . . , and 10n have similar configurations and FIG. 2 illustrates one of the cameras.

As shown in FIG. 2, the camera 10 has an image capturing part 11, an image storing part 12, an image processing part 13, a processed data storing part 14 and a measuring part 15.

The image capturing part 11 has an image pickup device such as a CCD and has the function of converting a light image of a subject to electronic data by a photoelectric converting action. A plurality of images captured by the image capturing part 11 is obtained as a motion picture and stored in the image storing part 12.

The measuring part 15 measures, for example, the number of persons included in an image captured by the image capturing part 11. More specifically, an image stored in the image storing part 12 is subjected to pre-processes by the image processing part 13. A measuring operation based on the pre-processed image is performed by the measuring part 15. The image processing part 13 performs, as pre-processes, imaging processes such as a background difference process, a motion difference process and a binarizing process. The image data subjected to such processes is temporarily stored in the processed data storing part 14. The measuring part 15 performs other imaging processes on the processed data stored in the processed data storing part 14, thereby counting the number of persons in the captured image.

The number of persons counting function performed by the measuring part 15 can be cancelled when it is unnecessary. The camera 10 can switch its processing mode between a “number of persons counting mode” in which the number of persons counting function by the measuring part 15 is made active and a “monitoring mode” in which the number of persons counting function by the measuring part 15 is made inactive and only acquisition of an image is performed. The “number of persons counting mode” is also expressed as a mode of counting the number of persons in an image, and the “monitoring mode” will be also expressed as a mode in which the number of persons in an image is not counted.

Referring again to FIG. 1, the controller 20 of FIG. 1 is constructed by a general computer such as a PC (Personal Computer) having a CPU, a memory, a hard disk, a display and the like. The controller 20 is disposed in a monitoring room or the like apart from the cameras 10.

The controller 20 is connected to the cameras 10 via communication lines. By using the connection, the controller 20 can receive various information (such as image data) transmitted from each of the cameras 10 and transmit various information (such as an image capture instruction) to the cameras 10. That is, the camera 10 and the controller 20 can transmit data to each other. The data communication system used between the camera 10 and the controller 20 is not limited to a wired system but may be a wireless system.

The controller 20 has a determining part 21 and a control part 22. The determining part 21 and the control part 22 are conceptually expressed processing parts whose functions are realized by executing a predetermined program with various kinds of hardware such as the CPU in the controller 20.

The determining part 21 is a processing part for making various determinations regarding environments around each of the cameras on the basis of detection information obtained by the measuring part 15. The control part 22 has the function of changing image capturing conditions of each of the cameras 10 on the basis of a result of determination of the determining part 21. That is, the control part 22 has the function of changing the image capturing conditions of any of a plurality of cameras (more specifically, a plurality of image pickup devices) on the basis of detection information obtained by the measuring part 15.

In the embodiment, the measuring part 15 (FIG. 2) built in the camera 10 obtains detection information and transmits the detection information to the controller 20, so that it is unnecessary to transmit a captured image itself from each of the cameras 10 to the controller 20. Since the information amount of detection information is smaller than that of a captured image itself, communication traffic between each of the cameras 10 and the controller 20 can be reduced.

Layout and the like of the cameras 10 will now be described.

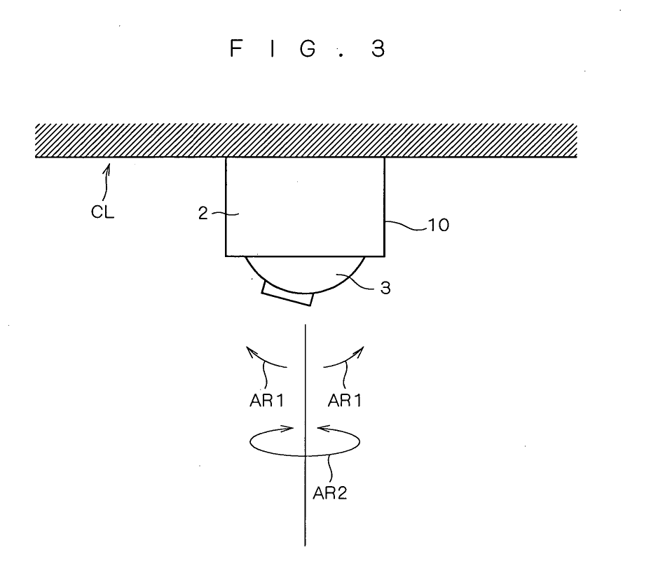

FIG. 3 is a side view of the camera 10. As shown in FIG. 3, each of the cameras 10 is mounted on a ceiling face CL in a shop.

The camera 10 has a body part 2 and a rotary part 3. The body part 2 is fixed to the ceiling face CL. The rotary part 3 has a lens and an image pickup device and can turn relative to the body part 2. Concretely, the rotary part 3 can rotate (swing) in the direction of an arrow AR1 and an angle of depression relative to the ceiling face of an optical axis of the built-in lens can be changed. The angle of depression can be also expressed as an angle of elevation relative to the floor face. Each of the angle of depression and the angle of elevation will be referred to as a tilt angle. The rotary part 3 can rotate (swing) in the rotation direction of an arrow AR2, so that the lens can be rotated around the vertical axis in a state where the optical axis of the built-in lens is inclined with respect to the vertical axis. The rotation angle around the vertical axis of the rotary part 3 will be also referred to as a pan angle. Further, the lens of the rotary part 3 has a function of changing its focal length, that is, a zooming function and can change the magnification (magnification of an image formed on a CCD), in other words, the angle of view.

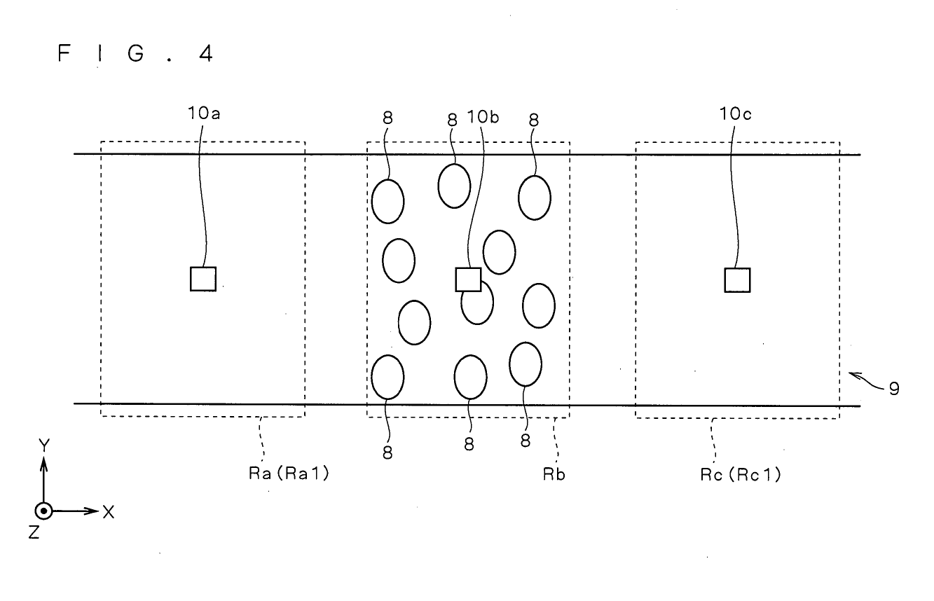

FIG. 4 is a top view showing layout of three cameras 10a, 10b and 10c out of the plurality of cameras 10a, 10b, 10c, 10d, . . . , and 10n and image capturing regions (monitoring regions) Ra, Rb and Rc. It is assumed herein that the cameras 10 are mounted on the ceiling face above a passage 9 in a shop. In FIG. 4, persons (human beings) 8 are drawn as ovals conceptually. Each of the image capturing regions Ra, Rb and Rc of the cameras changes according to a change in the angle of posture and the focal length (angle of view) of a corresponding camera. FIG. 4 shows image capturing regions Ra (Ra1), Rb and Rc (Rc1) in the reference postures (facing downward in the vertical direction) of each of the cameras 10a, 10b and 10c at a reference angle of view.

In the following description, at the time of indicating directions and orientation, an XYZ three-dimensional rectangular coordinate system shown in the figure will be properly used. The XYZ axes are relatively fixed to the passage 9. The X axis direction is a travel direction of a person as a movable body in the passage 9, the Y axis direction is a width direction of the passage 9 (direction orthogonal to the travel direction of persons), and the Z axis direction is the vertical direction.

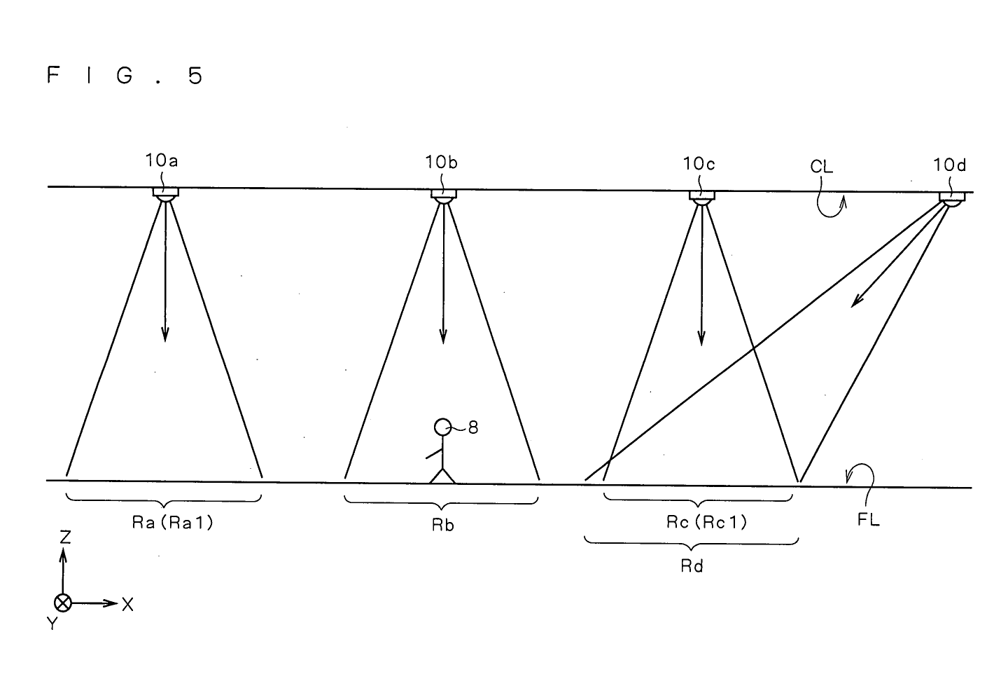

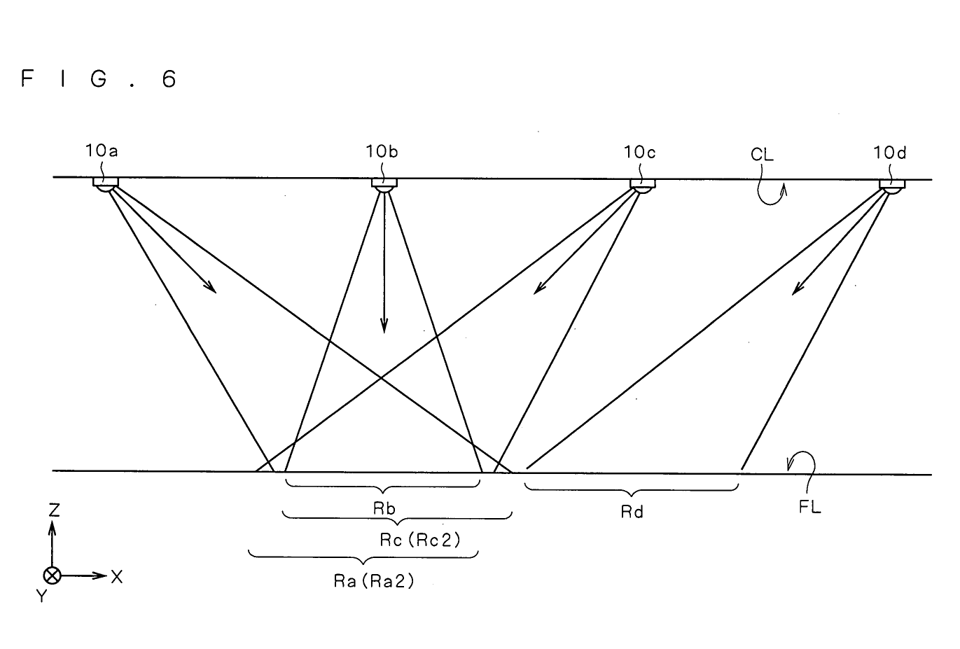

FIG. 5 is a side view showing the image capturing regions Ra(Ra1), Rb, Rc(Rc1) and Rd of the cameras 10a, 10b, 10c and 10d, respectively, in an initial state. On the floor face FL, as shown in FIG. 4, a plurality of persons 8 exists in reality. However, for convenience of the figure, only one person is shown in FIG. 5. In FIG. 6 and subsequent figures, the persons 8 are properly omitted.

In FIG. 5, all of the four cameras 10a, 10b, 10c and 10d are in a operating state. The three cameras 10a, 10b and 10c out of the four cameras operate in the “number of persons counting mode”. The cameras 10a, 10b and 10c capture images of the image capturing regions Ra (Ra1), Rb and Rc (Rc1), respectively, directly below the cameras 10a, 10b and 10c. The another camera 10d operates in the “monitoring mode”. The camera 10d captures an image of the region Rd which is almost the same as the region Rc1.

In some cases, it is found as a result of counting by the measuring part 15 of the camera 10b that the number of persons 8 included in the image capturing region Rb of the camera 10b exceeds a predetermined number (threshold) TH1 (for example, 10). In this case, the control part 22 of the controller 20 transmits a change command CM1 to the cameras 10a, 10c and 10d. The change command CM1 includes a command of changing the processing mode and/or a command of changing the image capturing region by changing the angle of posture or the like.

In this case, the change command CM1 includes a command of changing the image capturing regions of the cameras 10a and 10c by changing the angles of posture of the cameras 10a and 10c , and a command of changing the processing modes of the cameras 10a and 10c to the “monitoring mode”. The change command CM1 also includes a command of changing the processing mode of the camera 10d to the “number of persons counting mode”. On the other hand, the change command CM1 does not include a command of changing the image capturing regions of the cameras 10b and 10d and a command of changing the processing mode of the camera 10b. The cameras 10a, 10c and 10d change the image capturing conditions in response to such a change command CM1.

FIG. 6 is a side view showing the changed image capturing regions of the cameras 10a and 10c.

As shown in FIG. 6, the cameras 10a and 10c change the image capturing regions Ra and Rc by changing their angles of posture in response to the change command CM1. Concretely, the camera 10a captures the image of the image capturing region Ra2 which is almost the same as the image capturing region Rb of the camera 10b. The camera 10c also captures an image of the image capturing region Rc2 which is almost the same as the image capturing region Rb of the camera 10b. Each of the regions Ra2 and Rc2 can be also expressed as a region which includes almost the whole region Rb.

Therefore, images captured by the cameras 10a and 10c are obtained as images regarding the region Rb, so that a plurality of (three, in this case) images from various angles of the region Rb (see FIG. 4) in which the number of persons is large can be obtained.

The camera 10c changes, in response to the change command CM1, the image capturing region Rc from the region Rc1 (FIG. 5) to the region Rc2 (FIG. 6) which is almost the same as the region Rb and, after that, changes the processing mode from the “number of persons counting mode” to the “monitoring mode”. As a result, a monitoring image of the region Rb can be obtained without accompanying the number of persons counting operation, so that power consumption can be reduced. In short, it is efficient. The camera 10a operates in a similar way as the camera 10c. As will be described later, the number of persons counting operation of the region Rb is continued by the camera 10b.

Further, in response to the change command CM1, the camera 10d changes the processing mode from the “monitoring mode” to the “number of persons counting mode”, but the camera 10d does not change the image capturing region (Rd). The image capturing region Rd is almost the same as the region Rc1. Therefore, even when the camera 10c stops performing the process of counting the number of persons in the region Rc1 directly below the camera 10c in association with a change in the processing mode or the like, the number of persons existing in the region Rd which is almost the same as the region Rc1 can be counted by the number of persons counting process by the camera 10d. In other words, even in the case where an image of the region Rc1 directly below the camera 10c cannot be captured by the camera 10c, an image of the region Rc1 directly below the camera 10c can be captured by the camera 10d and the number of persons in the region can be counted.

The camera 10b continuously keeps on capturing images of the same region and continues the counting operation of the measuring part 15. For a period in which the number of persons 8 is larger than the predetermined value TH1, the camera 10b continues the monitoring operation (operation shown in FIG. 6) on the image capturing region Rb using also the cameras 10a and 10c. After that, when it is determined that the number of persons 8 becomes the predetermined value TH1 or less, the control part 22 of the controller 20 transmits a change command CM2 of resetting to the state of FIG. 5 (initial state) to the cameras 10a and 10c. The image capturing condition (state) of each of the cameras is reset to the state as shown in FIG. 5 in response to the change command CM2.

As described above, in the monitoring system 1 (1A), on the basis of an image captured by the camera 10b (specifically, the image pickup device of the camera 10b), information including the number of a plurality of persons included in the captured image is obtained as detection information. In the case where the number of persons detected is larger than the predetermined value TH1, the image capturing conditions (processing mode, image capturing region and the like) of the cameras 10a and 10c are changed, so that a plurality of persons can be monitored more efficiently.

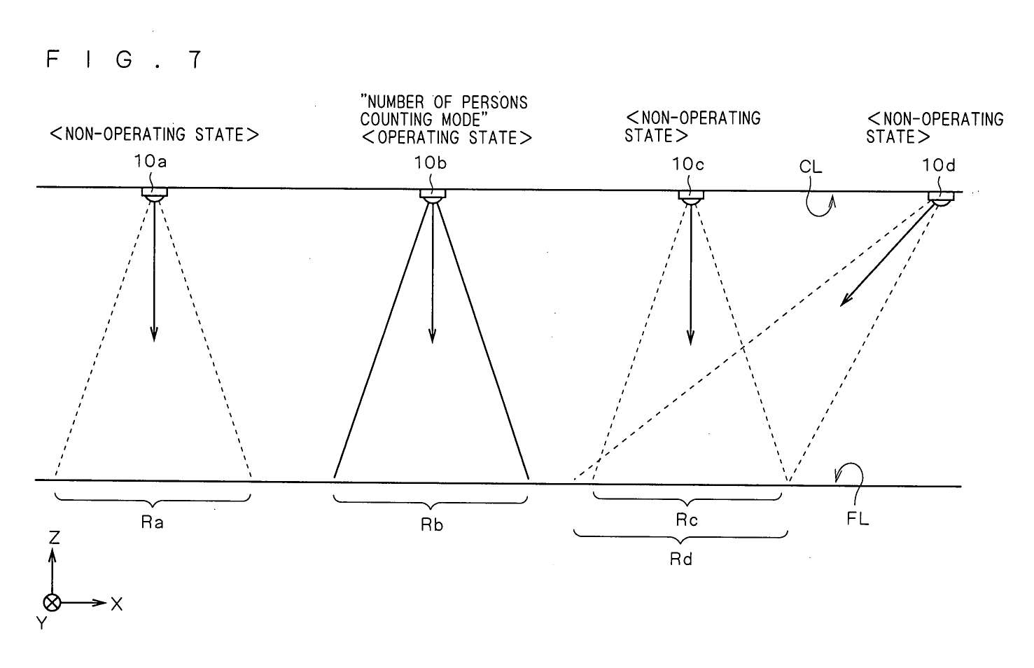

Although the case has been described where the cameras 10a to 10d are in an operating state even when the number of persons detected is equal to or smaller than the predetermined value TH1 as shown in FIG. 5, the present invention is not limited thereto. For example, as shown in FIG. 7, when the number of persons detected is equal to or smaller than the predetermined value TH1, the cameras 10a, 10c and 10d may be set in a non-operating state. FIG. 7 is a side view showing an image capturing state according to a modification.

Concretely, first, as shown in FIG. 7, only the camera 10b out of the four cameras 10a, 10b, 10c and 10d is set in the operating state (the state where images are captured) and the other cameras 10a, 10c and 10d are set in the non-operating state (state where no image is captured). More specifically, the camera 10b is allowed to operate in the “number of persons counting mode” and the number of persons in the image capturing region Rb is counted. The other cameras 10a, 10c and 10d do not perform the image capturing operation at all so that they can be also expressed that they are in a “non-operating state”.

And it is sufficient to change the state of each camera to a state as shown in FIG. 6 at the time point when the number of persons detected in the image capturing region Rb exceeds the predetermined number TH1. It is sufficient to reset the state of each camera to the state as shown in FIG. 7 at the time point when the number of detected persons in the image capturing region Rb becomes again the predetermined number TH1 or less.

By the operation according to such a modification, the number of a plurality of persons included in the image captured by the camera 10b is detected. In the case where the detected number of persons is larger than the predetermined value TH1, the image capturing conditions of the cameras 10a and 10c are changed (more specifically, the state is switched between the operating state and the non-operating state). Thus, a plurality of persons can be monitored more efficiently. By setting the non-operating mode, power consumption can be reduced.

Further, in the above embodiment and the like, setting of the picture quality and the like of a captured image may be changed. For example, at the time point when the detected number of persons in the image capturing region Rb exceeds the predetermined value TH1, the picture quality of the captured image in the region Rb may be improved. Specifically, the resolution of a captured image can be improved so that the number of pixels of a captured image is improved (from 640 pixels×480 pixels) to 1600 pixels×1200 pixels. Alternately, the compression ratio (for example, the compression ratio in MPEG compression) of a captured image may be changed, so that the image has higher picture quality. The changes in settings of picture quality (change in resolution and change in compression ratio) may be made not only for the camera 10b but also for the other cameras 10a and 10c.

### Second Preferred Embodiment

A monitoring system 1B of a second preferred embodiment is a modification of the monitoring system 1A of the first preferred embodiment and has a configuration similar to that of the monitoring system 1A according to the first preferred embodiment. In the following, different points will be mainly described.

In the first preferred embodiment, the case of performing image capturing concentratedly on the image capturing region Rb of the camera 10b by using the cameras 10a and 10c when the detected number of persons is larger than the predetermined value TH1 has been described. In the second preferred embodiment, a case of dividing the image capturing region Rb of the camera 10b and capturing images of the divided regions by using the cameras 10a and 10c when the detected number of persons is larger than the predetermined value TH1 will be described.

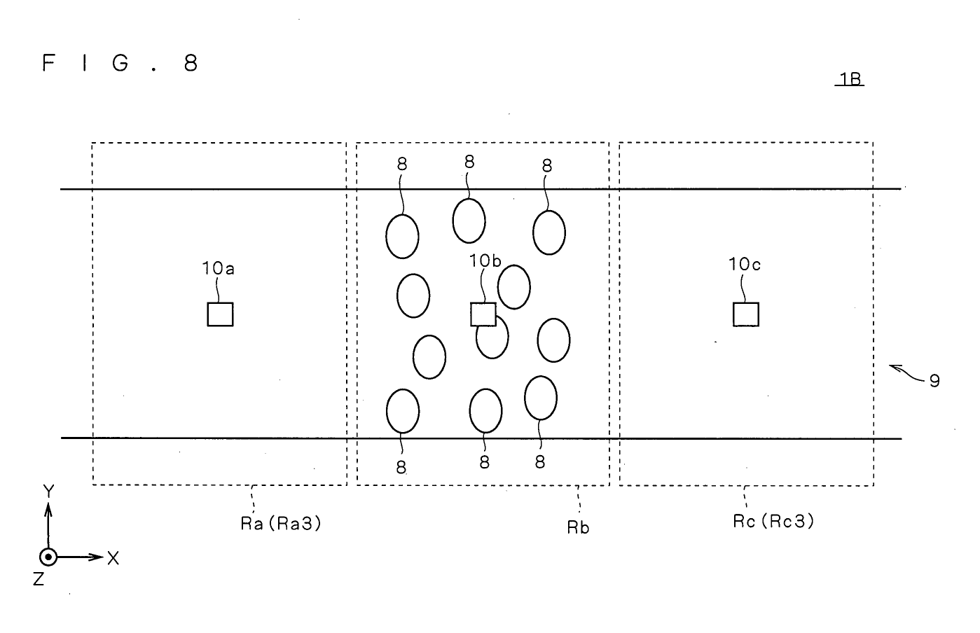

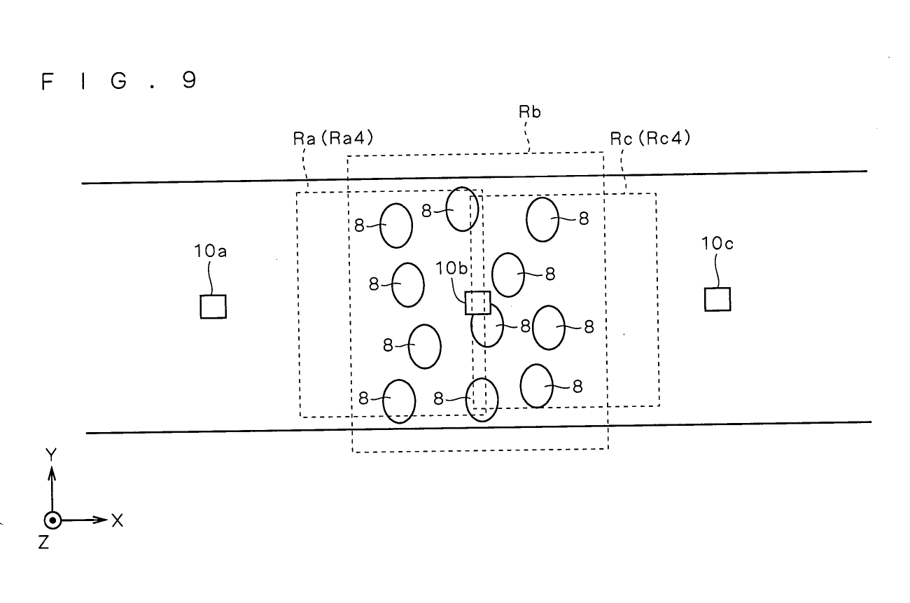

FIG. 8 is a diagram showing a region before division. FIG. 9 is a diagram showing divided image capturing regions. The control part 22 transmits an image capture instruction to realize an image capturing condition after division (see FIG. 9) to the cameras.

Concretely, in a manner similar to the first preferred embodiment, the number of persons in an image captured by the camera 10b is detected on the basis of the captured image, when the detected number of persons is larger than the predetermined value TH1, an instruction for changing the image capturing region is transmitted from the control part 22 to the cameras.

In response to the change instruction, the image capturing regions Ra and Rc of the cameras 10a and 10c are changed from the regions Ra3 and Rc3 as shown in FIG. 8 to regions Ra4 and Rc4 as shown in FIG. 9. The regions Ra4 and Rc4 in FIG. 9 are regions obtained by dividing almost the whole region Rb into halves. That is, the cameras 10a and 10c share capturing of an image of the image capturing region Rb of the camera 10b.

After division, both of the cameras 10a and 10c operate in the “member of persons counting mode” and count the number of persons existing in each of the regions Ra4 and Rc4 on the basis of captured images of the regions Ra4 and Rc4, respectively. Concretely, the measuring part 15 of the camera 10a counts the number of persons in the image capturing region Ra4, and the measuring part 15 of the camera 10c counts the number of persons in the image capturing region Rc4. That is, the two cameras 10a and 10c share counting of the number of persons existing in the region Rb (and its periphery).

According to the embodiment, also in the case where a number of persons are concentrated in a certain area (around the center of the diagram) and the processing load (calculation load) becomes too heavy for a single camera, the process can be shared by (measuring parts 15 of) two cameras and the number of persons counting process can be continuously performed. That is, the number of persons counting operation can be performed more efficiently.

The camera 10b operates while changing its processing mode from the “number of persons counting mode” to the “monitoring mode”. The camera 10b continuously captures an image in the region Rb, so that various monitoring images of the crowded region Rb can be obtained. Although the camera 10b captures an image of the image capturing region Rb, it does not count the number of persons, so that power consumption can be reduced.

### Third Preferred Embodiment

A monitoring system 1C of a third preferred embodiment is a modification of the monitoring system 1A of the first preferred embodiment and has a configuration and the like similar to that of the monitoring system 1A according to the first preferred embodiment. In the following, the different points will be mainly described.

In the third preferred embodiment, the case of capturing an image of the crowded area Rb by changing the angle of view of a camera (more specifically, changing to the wide side) will be described.

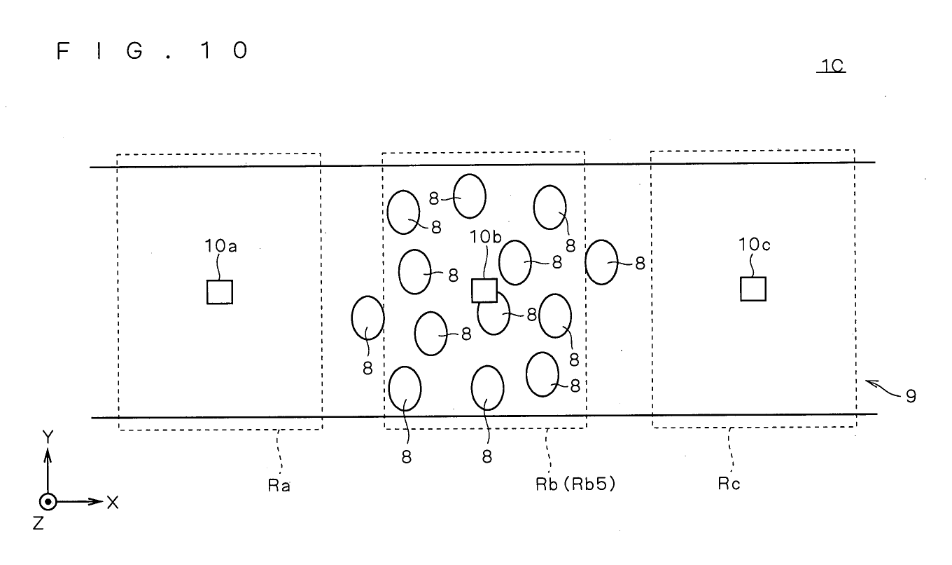

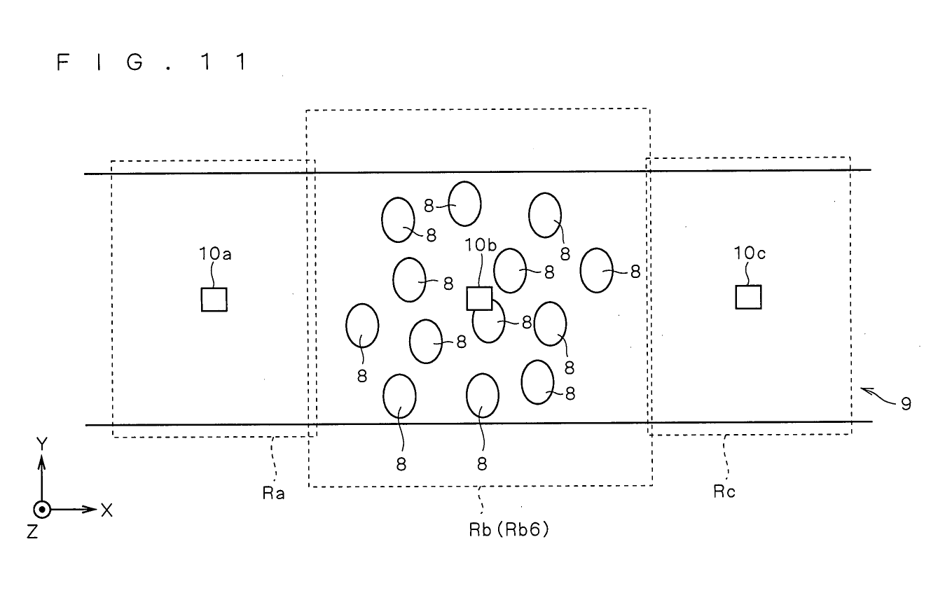

FIG. 10 is a diagram showing an image capturing region Rb (Rb5) before the angle of view is changed. After that, when it is determined that the detected number of persons in the region Rb exceeds the predetermined value TH1, the image capturing region of the camera is changed as shown in FIG. 11. FIG. 11 is a diagram showing an image capturing region Rb (Rb6) after the angle of view is changed.

Concretely, the angle of view of the camera 10b is changed to the wide side and the image capturing region Rb itself of the camera 10b is changed to the region Rb6 on the wide side. By the change, an image in a wider range can be captured, so that the region in which persons are concentrated (crowded region) Rb can be watched with a wider field of view. For example, whether other persons exist on the outside of the region Rb5 or not can be also recognized.

On the other hand, the cameras 10a and 10c keep on capturing images of the same regions. The present invention, however, is not limited thereto. The posture angles of the cameras 10a and 10c may be altered to change the image capturing regions. For example, it is also possible to shift the image capturing region of the camera 10a to the region Rb6 side. By the shift, an image around the crowded region Rb6 can be further captured. The operation of the camera 10c is also similar to the above. In order to assure a wider field of view from various viewpoints, it is preferable to change the angle of view of each of the cameras 10a and 10c to the wide side.

In the third preferred embodiment, the processing mode of each of the cameras may be the “number of persons counting mode” or “monitoring mode”.

### Fourth Preferred Embodiment

In a fourth preferred embodiment, a case of changing an image capturing region (image capturing conditions) of each camera in accordance with travel (movement) of persons will be described. Concretely, on the basis of detection information including travel directions (moving directions) of a plurality of persons included in an image captured by at least one of the plurality of cameras 10a, 10b, 10c, . . . and 10n, travel information of persons is generated. On the basis of the travel information, an image capturing region is changed.

A monitoring system 1D according to the fourth preferred embodiment has a configuration and the like similar to those of the monitoring system 1A according to the first preferred embodiment. In the following, points different from the first preferred embodiment will be mainly described.

The determining part 21 (FIG. 1) of the monitoring system 1D estimates a travel state of persons on the basis of detection information regarding the number of persons and the like from the cameras 10.

In the fourth preferred embodiment, the measuring part 15 of each of the cameras 10 measures the number of traveling persons in a corresponding image capturing region and also measures travel directions of the persons. Concretely, by performing processes such as time difference process, space difference process and the like on a plurality of time-series images in each of the image capturing regions, the number of traveling persons existing in the region and the travel direction of each traveling person are measured. The travel speed of each of the traveling persons may be also measured.

First, the determining part 21 collects measurement results of the measuring parts 15 of the plurality of cameras 10 and determines the travel situations of persons.

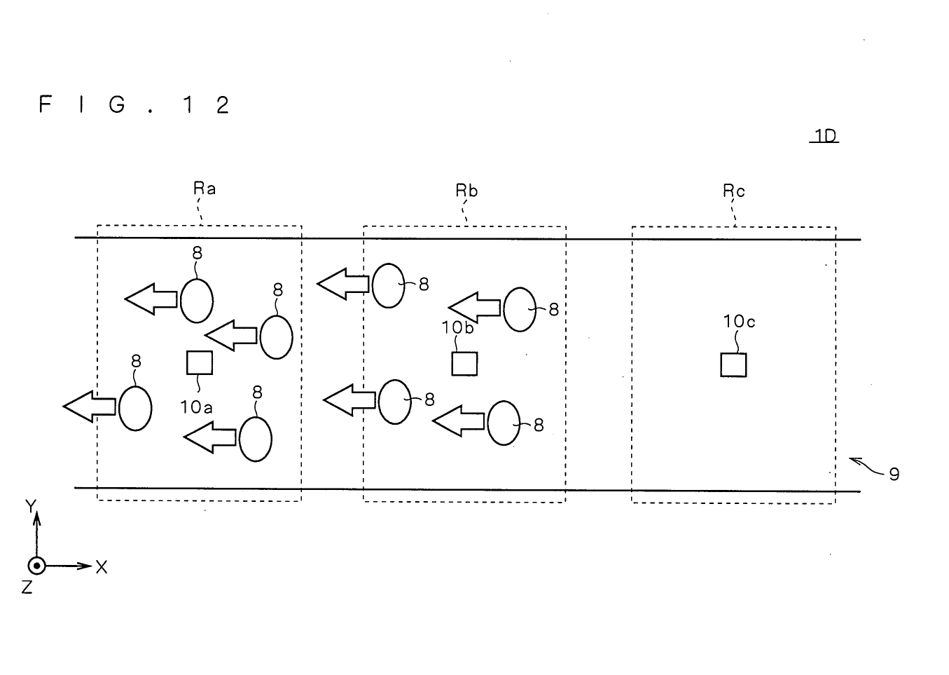

FIG. 12 is a top view showing the passage 9 extending in the X direction (lateral direction).

For example, with respect to the travel situations of persons in the passage 9 as shown in FIG. 12, the travel directions of persons can be grasped by being broadly divided to a direction to the left (toward −X) and a direction to the right (toward +X) in the passage 9. More specifically, the determining part 21 recognizes that four persons 8 in the region Ra travel to the −X side (to the left in the figure) and four persons 8 in the region Rb travel to the −X side (to the left in the figure). That is, in this case, it is recognized that all of eight persons as objects of image capturing travel to the left.

Measurement data regarding the flow of persons is expressed as, for example, “the ratio between the number of persons traveling to the left and the number of persons traveling to the right among the detected number of traveling persons (total number N)=7:3”. An average value of travel speeds of a plurality of persons may be also calculated in each of the travel directions.

At the time of grasping a travel state of persons, it is not always requested to accurately count the number of persons, but it is sufficient to obtain information regarding the direction of the flow of persons. Therefore, a computing process for obtaining the number may be properly simplified.

Next, the control part 22 changes the image capturing region (image capturing situations) of each camera to a significant monitoring region on the basis of travel information in the determining part 21.

Existing concrete changing techniques are (1) a technique TN1 for selecting a region in which persons are dense as the significant monitoring region, and (2) a technique TN2 of selecting a region in which persons are non-dense (sparse) as the significant monitoring region.

In the technique TN1, as shown in FIG. 12, in the case where it is determined that many persons travel to the left, the image capturing region of the camera is changed so as to capture an image of a region on the left side of the image capturing region. Concretely, the image capturing region of the camera 10a is changed so as to capture an image of a region on the further −X side of the region just below the camera 10a.

According to the technique TN1, when persons are dense on the left side, an image of the region can be captured by the camera 10a on estimation that the possibility that a some trouble or the like will occur on the left side is high or there is the possibility that an event to which many persons pay attention (for example, an accident) occurs.

On the other hand, in the technique TN2, when it is determined that many persons travel to the left as shown in FIG. 12, the image capturing region of the camera is changed so as to capture an image of a region on the right side of the region. Concretely, the image capturing region of the camera 10a is changed so as to capture an image on the further +X side of the region just below the camera 10a.

According to the technique TN2, when persons are dense on the left side, the number of persons on the right side decreases. Therefore, it is predicted that the possibility of occurrence of a crime on the right-side region increases or there is the possibility that an event that persons feel danger (for example, fire) occurs on the right-side region, and an image of the region can be captured by the camera 10a.

Although the case of changing the image capturing region of the camera 10a has been described above, the present invention is not limited thereto. For example, not only the image capturing region of the camera 10a but also the image capturing region of the camera 10b may be similarly changed.

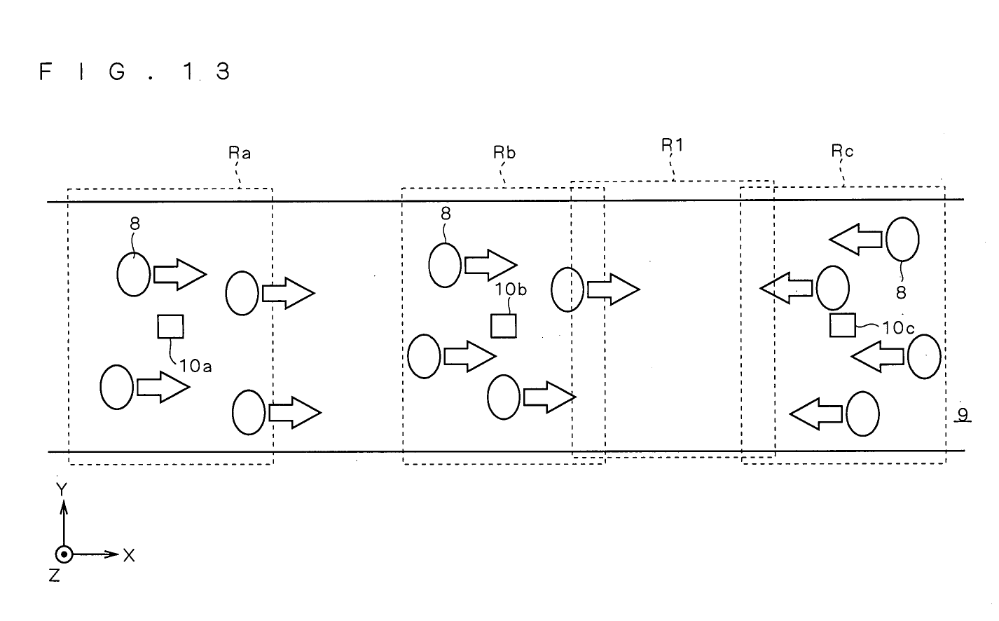

FIG. 13 is a top view showing another example of the travel state of persons in the passage 9.

For example, in FIG. 13, it is recognized by the determining part 21 that total eight persons 8 in the regions Ra and Rb travel to the +X side (to the right side of the diagram), and four persons 8 in the region Rc travel to the −X side (to the left side of the diagram). A result of the recognition is generated as travel information of persons. Further, the determining part 21 estimates that persons crowds (or are going to crowd) in the region R1 between the regions Rb and Rc.

The control part 22 changes the image capturing region (image capturing condition) of each of the cameras 10 on the basis of such a result of estimation. For example, by applying the technique TN1, the image capturing region of the camera 10b is changed from the region Rb to the region R1, and the image capturing region of the camera 10c is also changed from the region Rc to the region R1. In other words, the region R1 is selected as the significant monitoring region, and the image capturing regions of the cameras 10b and 10c are changed to the significant monitoring region (R1).

As described above, in the monitoring system 1 (1D), on the basis of an image captured by at least one of the cameras 10a, 10b and 10c, information regarding the travel directions and the like of a plurality of persons included in the captured image is obtained as detection information. On the basis of the travel information generated based on the travel directions, the image capturing condition of any of the cameras 10a, 10b and 10c is changed. Since the image capturing region of each of the cameras is changed in consideration of the travel directions of persons, a plurality of persons can be monitored more efficiently.

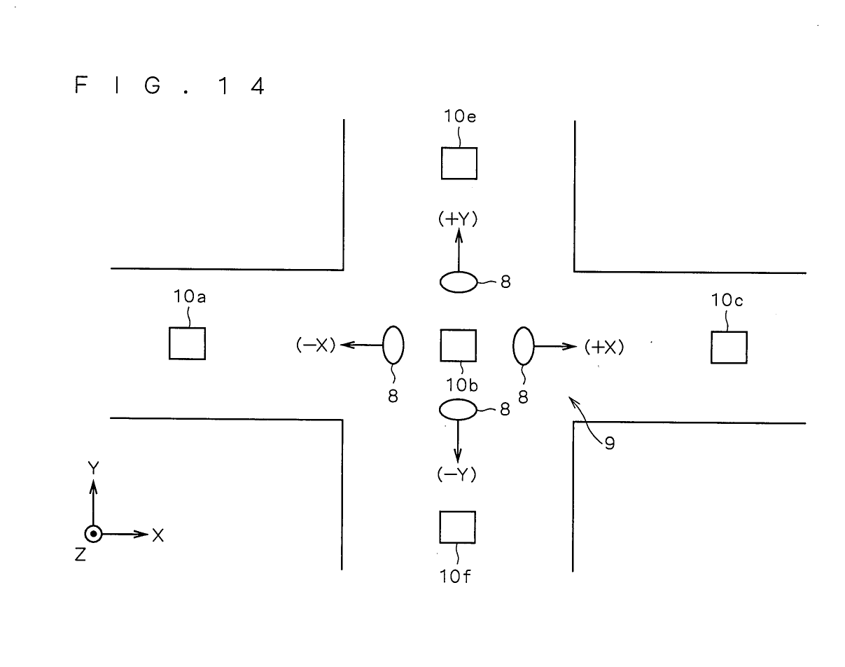

Although the case of roughly dividing the travel direction into two right and left directions has been described above, the present invention is not limited thereto. For example, as shown in FIG. 14, four travel directions of up, down, right and left (+Y, −Y, +X and −X) may be discriminated from each other and recognized. FIG. 14 is a top view of a region where two passages cross each other.

### Fifth Preferred Embodiment

In a fifth preferred embodiment, a case of tracing a specific person and changing the image capturing condition (image capturing region) of each of cameras in accordance with the travel direction of the person will be described. Concretely, on the basis of an image captured by at least one of a plurality of cameras 10a, 10b, 10c, . . . (hereinafter, the camera 10b), detection information including the travel directions of a plurality of persons included in the captured image is obtained. A camera used for tracing a person to be traced is determined on the basis of the travel direction of the person to be traced, and a front view image of the person to be traced is captured by the determined camera.

A monitoring system 1E according to the fifth preferred embodiment has a configuration similar to that of the monitoring system 1A according to the first preferred embodiment. In the following, points different from the first preferred embodiment will be mainly described.

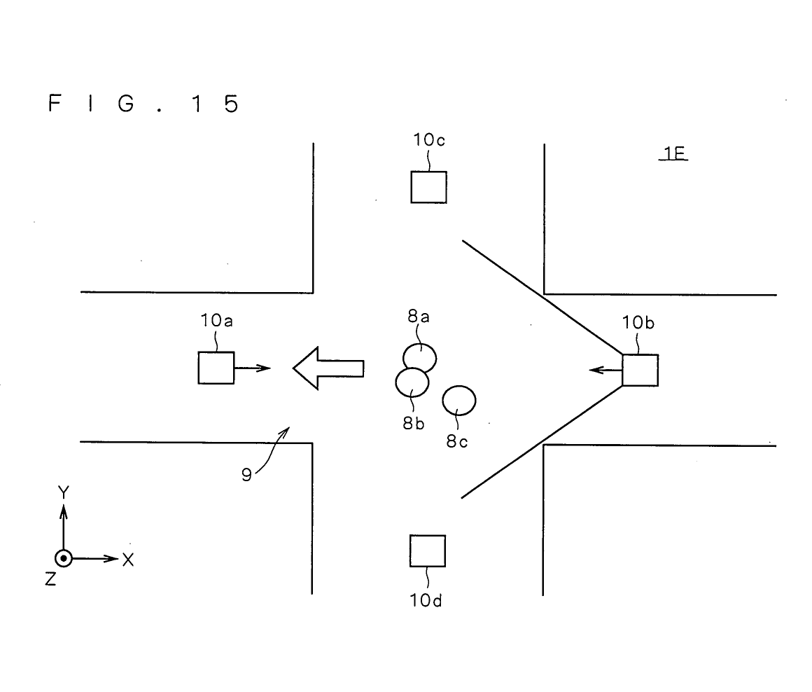

FIG. 15 is a top view showing an example of layout of the cameras 10a, 10b, 10c and 10d in the monitoring system 1E of the fifth preferred embodiment. In FIG. 15, a situation is assumed such that all of a plurality of (three in this case) persons travel from the right side to the left side of the diagram (that is, to the left).

First, referring to FIG. 15, a case of tracing the persons will now be described.

The camera 10b attached to the ceiling above the passage 9 captures an image of a region around the crossing point while tilting the optical axis of the lens of the camera 10b downward with respect to the ceiling face by a predetermined angle (for example, 30 degrees). The angle of view is set to the wide side to capture an image of a relatively wide range. The measuring part 15 of the camera 10b analyzes an image captured by the camera 10b and detects that the number of persons in the image capturing region is three and all of the three persons travel to the left side of the diagram (toward −X).

When the travel information of the three persons 8a, 8b and 8c is received from the camera 10b, the determining part 21 regards the three persons who travel in the same direction as a group G0 and recognizes that the travel direction of the group G0 is the direction to the left side (toward −X).

The control part 22 determines a camera for tracing and image-capturing in accordance with the travel direction of the persons in order to trace the three persons 8a, 8b and 8c included in the group G0.

Concretely, a camera satisfying conditions such that the camera exists on the travel destination side of the persons 8a, 8b and 8c to be traced and/or the distance between the camera and the persons to be traced is short is determined as a camera for tracing and image-capturing. For example, in FIG. 15, the camera 10a is determined as a camera for tracing and image-capturing.

To be specific, the control part 22 determines a camera satisfying the above-described conditions on the basis of layout information of the cameras.

The control part 22 gives an image capturing instruction to the camera 10a determined as a camera for tracing and image-capturing. Concretely, a setting instruction regarding the angle of posture and the angle of view to capture a front view image of the persons 8a, 8b and 8c is given. For example, in FIG. 15, a setting instruction to set a pan angle at which the orientation of the camera 10a becomes to the right side of the figure (toward the +X) and a tilt angle at which the camera 10a is oriented slightly downward is given. The angle of view (focal length or zoom magnification) is determined as a value by which three persons are within a screen (for example, a value on a relatively wide angle side). It is preferable to determine a proper angle-of-view value according to the distance between the camera 10a and the three persons so that the three persons are captured as large as possible in the captured image.

As a result, an image (front view image) seen from the front side of the three persons 8a, 8b and 8c is captured by the camera 10a. That is, a front view image of the persons to be traced is captured.

It is preferable to check whether a person newly captured by the camera 10a is the same person as that captured by the camera 10b by various identifying methods. For example, it is sufficient to obtain the position in which a person exists on the basis of information regarding the angle of posture and the angle of view of a camera, information regarding position of the camera, and the like. In such a manner, whether persons captured by the cameras 10a and 10b are the same or not can be checked, and more reliable tracing operation can be performed.

Also after passing the tracing operation to the cameras 10a and 10c, the camera 10b keeps on capturing an image of a relatively wide range. That is, the camera 10b is continuously used as a camera for wide-range monitoring.

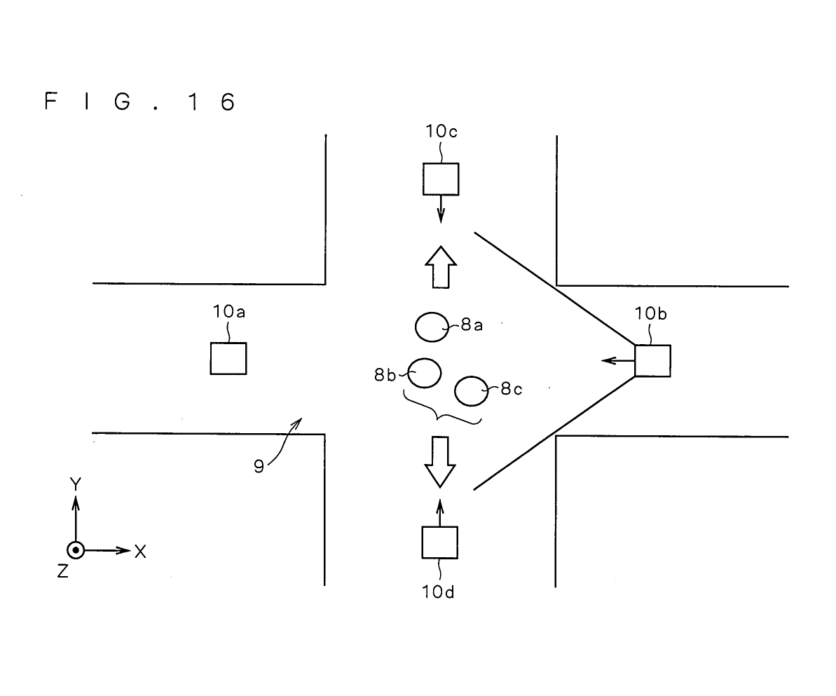

Referring now to FIG. 16, operation of tracing a plurality of persons traveling in different directions will be described.

FIG. 16 is a diagram similar to FIG. 15 except that the travel directions of the persons 8a, 8b and 8c are different. Particularly, in the case where a plurality of persons travel in a plurality of different directions, it is difficult to trace each of the persons by one camera 10b. Even in such a case, operation of tracing a plurality of persons can be performed by cooperation of a plurality of cameras (10a and 10c ) as described below.

First, the camera 10b captures an image of an area around a crossing point in a manner similar to the above. The measuring part 15 of the camera 10b analyzes the captured image and detects that the number of persons in the image capturing region is three, a person 8a as one of the three persons travels to the up (+Y direction) in FIG. 16, and the other two persons 8b and 8c travel to the down (−Y direction) in FIG. 16.

When travel information of the three persons 8a, 8b and 8c is received from the camera 10b, the determining part 21 regards the person 8a as a group G1 and regards the persons 8a and 8b as another group G2. The determining part 21 recognizes that the travel direction of the group G1 is a direction to the up (+Y direction) in the figure, and the travel direction of the group G2 is a direction to the down (−Y direction) in the figure.

The control part 22 determines a camera for tracing and image-capturing in accordance with the travel directions of the groups G1 and G2 in order to trace the three persons 8a, 8b and 8c on the group unit basis. Concretely, as shown in FIG. 16, the camera 10c is determined as a camera for tracing and image-capturing for the group G1, and the camera 10d is determined as a camera for tracing and image-capturing for the group G2.

The control part 22 gives an image capturing instruction to the cameras 10c and 10d determined as the cameras for tracing and image-capturing. Concretely, a setting instruction regarding the angle of posture and the angle of view to capture a front view image of the person 8a is given to the camera 10c. A setting instruction regarding the angle of posture and the angle of view to capture a front view image of the persons 8b and 8c is given to the camera 10d.

As a result, front view images of the persons to be traced are captured. Concretely, a front view image of the person 8a is captured by the camera 10c, and a front view image of the persons 8b and 8c is captured by the camera 10d.

As described above, in the monitoring system 1 (1E), information regarding the travel directions and the like of a plurality of persons included in an image captured by the camera 10b is obtained as detection information on the basis of the captured image. According to the travel directions, a camera for tracing and image-capturing corresponding to each of the persons is determined. An image capturing instruction for capturing a front view image of each of the persons is given to each of the determined cameras. Therefore, the cameras can trace a plurality of persons in liaison with each other. Since a front view image can be captured, the system is very convenient.

Although the case where persons travel in four directions has been described above, the present invention can be also applied to the case of the larger number of directions (for example, eight travel directions).

Although the case where a plurality of persons in a plurality of groups travel in a plurality of directions at an intersecting point has been described above, when it is recognized that a plurality of groups travel in the same direction, it is sufficient to deal the plurality of groups as a single group.

### Sixth Preferred Embodiment

In a sixth preferred embodiment, a case of selecting a person to be traced from a plurality of persons included in an image captured by a camera and tracing the specific person (selected person) will be described. More specifically, a case of using the monitoring system as a crime prevention camera system in a shop or the like will be described.

A monitoring system 1F according to a sixth preferred embodiment has a configuration similar to that of the monitoring system 1A of the first preferred embodiment. In the following, points different from the first preferred embodiment will be mainly described.

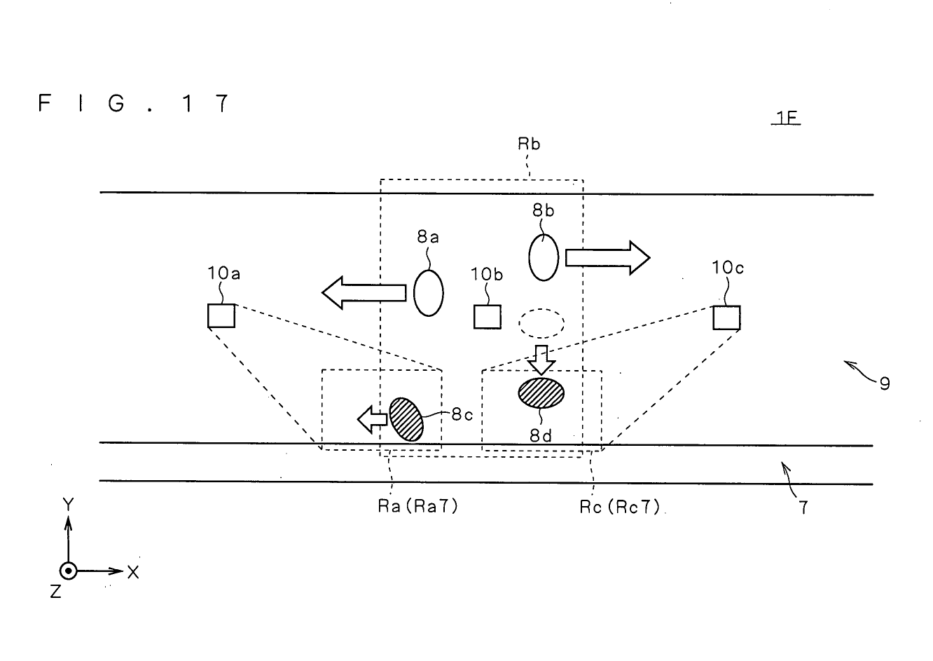

FIG. 17 is a top view showing an example of layout of the cameras 10a, 10b and 10c in the monitoring system 1F of the sixth preferred embodiment.

In FIG. 17, the camera 10b in the center captures an image of the region Rb directly below the camera 10b at an angle of view on the wide angle side. In an image captured by the camera 10b, a plurality of (four, in this example) persons 8a, 8b, 8c and 8d are captured.

In this case, all of the persons 8a, 8b, 8c and 8d may be traced. In a shop, however, it is desired to trace the person 8d approaching a commodity shelf and/or the person 8c close to the commodity shelf more concentratedly than the persons 8a and 8b just passing the passage. In other words, the degree of demand (importance) of trace varies according to the positions and the travel directions of the persons.

In the embodiment, only the persons (8c and 8d) having importance of trace higher than a predetermined degree are traced. In such a manner, limited camera resources can be used effectively, so that efficient tracing operation can be performed.

In the sixth preferred embodiment, the measuring part 15 of each of the cameras 10 measures the number of traveling persons in a corresponding image capturing region and also measures the existing position and the travel direction of each of the persons. In other words, detection information as a result of measurement includes data of the existing positions and travel directions of the plurality of persons 8a, 8b, 8c and 8d in an image captured by the camera 10a.

The determining part 21 receives and obtains a result of measurement by the measuring part 15 of the camera 10a from the camera 10a. It is assumed that, at this time point, the cameras 10a and 10c are in a non-operating state.

The control part 22 selects a person to be traced from the plurality of persons 8a, 8b, 8c and 8d in accordance with detection information. Concretely, the person 8c in a position close to a commodity shelf 7 (for example, within 1 meter from the commodity shelf) is determined as a person having high degree of demand of trace, in other words, high degree of importance of trace and satisfying a predetermined condition of an object to be selected. Likewise, a person determined as a person approaching the commodity shelf 7 from its travel direction is also a person having high degree of importance of trace and is determined as a person satisfy the predetermined condition of the object to be selected.

The control part 22 changes the image capturing regions of the cameras 10a and 10c so as to capture images of the selected persons 8c and 8d. Concretely, the control part 22 instructs the camera 10a to capture an image of the person 8c, and instructs the camera 10c to capture an image of the person 8d. The posture angle and the angle of view of the camera 10a are properly determined on the basis of the positional relation between the camera 10a and the person 8c, and the like. The angle of posture and the angle of view of the camera 10c are determined similarly. The angle of view is preferably determined as a value at which an image of a person as an object to be traced can be captured as large as possible.

As described above, in the monitoring system 1F, a person to be traced is selected from a plurality of persons captured by the camera 10b in accordance with detection information and an image of the selected person is captured. Thus, efficient tracing operation can be performed.

Modifications

Although the case where the measuring part 15 (FIG. 2) is provided in the camera 10 has been described above in the foregoing embodiments, the present invention is not limited thereto. The measuring part 15 may be provided on the outside of the camera 10. For example, the measuring part 15 may be provided in the controller 20 (FIG. 1). In this case, by preliminarily reducing an amount of image data by pre-process of the image processing part 13 (FIG. 2), communication traffic can be reduced at the time of transmitting image data of a captured image to the controller 20 so as to be used for the number of persons counting process.

Although the case where the determining part 21 and the control part 22 are provided on the outside of each of the cameras has been described in the foregoing embodiments, the present invention is not limited thereto. The determining part 21 and the control part 22 may be provided in any of the plurality of cameras. For example, the determining part 21 and the control part 22 may be provided in the body part 2 of the camera 10b.

While the invention has been shown and described in detail, the foregoing description is in all aspects illustrative and not restrictive. It is therefore understood that numerous modifications and variations can be devised without departing from the scope of the invention.

1. A monitoring system comprising:
a plurality of image capturing parts;
an information obtaining part for obtaining detection information regarding a plurality of persons included in an image captured by at least one of said plurality of image capturing parts on the basis of said image; and
a controller for changing an image capturing condition of at least one of said plurality of image capturing parts on the basis of said detection information.

2. The monitoring system according to claim 1, wherein
said detection information includes data regarding the number of said plurality of persons, and
said controller changes an image capturing condition of at least one of said plurality of image capturing part when the number of said plurality of persons is larger than a predetermined value.

3. The monitoring system according to claim 2, wherein
said controller switches at least one of said plurality of image capturing parts between an operating state and a non-operating state.

4. The monitoring system according to claim 2, wherein
said controller switches a processing mode of at least one of said plurality of image capturing parts between a first mode, in which said image capturing part counts the number of persons in an image, and a second mode, in which said image capturing part does not count the number of persons in an image.

5. The monitoring system according to claim 2, wherein
said controller changes setting of picture quality of an image captured by at least one of said plurality of image capturing parts.

6. The monitoring system according to claim 2, wherein
said controller changes an image capturing region of at least one of said plurality of image capturing parts.

7. The monitoring system according to claim 6, wherein
said plurality of image capturing parts include a first image capturing part, a second image capturing part and a third image capturing part,
said information obtaining part includes first to third measuring parts for respectively counting the number of persons included in each image which is captured by each of said first to third image capturing parts, and
said controller changes an image capturing region of said second image capturing part and an image capturing region of said third image capturing part so that an image capturing region of said first image capturing part at a particular time point is shared and captured by said second and third image capturing parts.

8. The monitoring system according to claim 6, wherein
said plurality of image capturing parts include a first image capturing part,
said detection information is detected on the basis of an image captured by said first image capturing part, and
said controller changes an angle of view of said first image capturing part to a wide side.

9. The monitoring system according to claim 1, wherein
said detection information includes data regarding travel directions of said plurality of persons, and
said controller changes an image capturing region of at least one of said plurality of image capturing parts on the basis of the data regarding said travel directions.

10. The monitoring system according to claim 9, wherein
said controller changes said image capturing region on the basis of said data regarding said travel directions so that an image of a crowded region is captured.

11. The monitoring system according to claim 9, wherein
said controller changes said image capturing region on the basis of said data regarding said travel directions so that an image of a sparse region is captured.

12. The monitoring system according to claim 1, wherein
said detection information includes data regarding travel directions of said plurality of persons, and
said controller determines a particular image capturing part corresponding to at least one of said plurality of persons on the basis of said data, and instructs said particular image capturing part to capture a front view image of said at least one of said plurality of persons.

13. The monitoring system according to claim 1, wherein
said detection information includes data regarding existing positions and travel directions of said plurality of persons included in said image, and
said controller selects a particular person to be traced from said plurality of persons in accordance with said detection information and changes an image capturing region of said at least one of said plurality of image capturing parts so that an image of said particular person is captured.

14. A monitoring method executed by a monitoring system having a controller connected to a plurality of image capturing devices, comprising the steps of:
obtaining images by said plurality of image capturing devices;
obtaining detection information regarding a plurality of persons included in an image captured by at least one of said plurality of image capturing parts on the basis of said image; and
changing an image capturing condition of at least one of said plurality of image capturing devices on the basis of said detection information.

15. A computer program product including a program executed by a computer provided in a controller connected to a plurality of image capturing devices, comprising the steps of:
obtaining images by said plurality of image capturing devices;
obtaining detection information regarding a plurality of persons included in an image captured by at least one of said plurality of image capturing parts on the basis of said image; and
changing an image capturing condition of at least one of said plurality of image capturing devices on the basis of said detection information.

16. The computer program product according to claim 15, wherein
said detection information includes data regarding the number of said plurality of persons, and
the image capturing condition of at least one of said plurality of image capturing devices is changed when the number of said plurality of persons is larger than a predetermined value.

17. A monitoring system comprising:
a plurality of image capturing parts;
an information obtaining part for obtaining detection information regarding travel directions of a plurality of persons on the basis of an image captured by at least one of said plurality of image capturing parts; and
a controller for determining a particular image capturing part corresponding to at least one of said plurality of persons on the basis of said travel directions of said plurality of persons, and instructing said particular image capturing part to capture a front view image of said at least one of said plurality of persons.
